(19) United States
(12) Patent Application Publication
(10) Pub. No.: US 2011/0065879 A1
(43) Pub. Date: Mar. 17, 2011

(54) Non-Ionic Water-Soluble Additives Based on Allyl Ether and Vinyl Ether

(75) Inventors: Bjoern Fechner, Eppstein (DE); Carsten Schaefer, Muehldorf am Inn (DE); Alexander Woerndle, Frankfurt am Main (DE)

(73) Assignee: CLARIANT FINANCE (BVI) LIMITED, Tortola (VG)

(21) Appl. No.: 12/674,083

(22) PCT Filed: Jul. 23, 2008
(86) PCT No.: PCT/EP2008/006023

§ 371 Date: Feb. 18, 2010

(30) Foreign Application Priority Data
Aug. 23, 2007 (DE) 102007039785.4
Jul. 23, 2008 (EP) PCT/EP2008/006023

(51) Int. Cl. C08F 226/06; C08F 220/10; C08F 224/00

(52) U.S. Cl. 526/263; 526/327; 526/270; 526/284

(57) ABSTRACT

The invention relates to a copolymer that can be obtained by the polymerization of the monomers (A), (B) and (C), (A) being a monomer of formula (I) wherein A is C₂-C₄ alkylene and B is a C₂-C₄-alkylene different from A, k corresponds to the number 0 or 1, m is a number between 0 and 500, n is a number between 0 and 500, the sum of m+n being equal to between 1 and 1000; (B) contains an ethylenically unsaturated monomer containing an aromatic group; and (C) is an ethylenically unsaturated monomer containing an alkyl radical. The copolymers according to the invention are suitable as dispersants for pigments.

The present invention relates to novel nonionic copolymers useful as dispersants for waterborne pigment formulations and to a process for preparing these copolymers.

The hitherto customary novolak-based nonionic dispersants contain as a consequence of their method of synthesis residues of alkylphenols, frequently nonylphenol, and ethoxylates thereof. Since alkylphenol ethoxylates, or their degradation products, scarcely undergo any degradation in the environment, they build up. This is problematic in that they have a hormonal effect on aquatic organisms. Therefore, many countries have adopted legislation (2003/53/EC for example) which limits or bans the use of materials containing alkylphenols or their ethoxylates in open-loop systems.

US 2005 085 563 describes dispersants obtained by copolymerization of vinyl-functionalized polyethers and styrene oxide.

EP-A-0 894 811 and EP-A-0 736 553 describe copolymers based on unsaturated carboxylic acid derivatives and oxyalkylene glycol alkyl ethers and also a dicarboxylic acid derivative that are useful in hydraulic binders, particularly cement.

DE-A-100 17 667 describes the use of such copolymers for preparing aqueous pigment formulations.

Studies to date have shown that it is still extremely difficult to synthesize dispersants that are equivalent to nonionic novolak systems. There is accordingly a need for novel dispersants that are capable of dispersing organic pigments in high concentration above 40% to low-viscosity dispersions. These dispersions shall be straightforward to produce, i.e., the pigments shall be readily wetted and be readily incorporated into the aqueous medium. The dispersion shall have a high and reproducible color strength and this shall remain stable for a period of several years. Similarly, all further coloristic parameters such as, for example, hue angle and chroma shall be reproducible and stable. Furthermore, the dispersion shall have a low viscosity; the pigments must neither agglomerate nor flocculate nor cream up or form a sediment. The dispersion should not foam or cause or speed foaming in the application medium. Furthermore, the dispersants should contribute to broad compatibility of the dispersions in various application media. Moreover, the dispersion shall be shear stable; i.e., its color strength or coloristics must not change under shearing, and the dispersion shall remain resistant to flocculation under these conditions.

It has now been found that, surprisingly, specific nonionic comb copolymers, prepared by means of macromonomers composed of polyethylene/polypropylene glycol monovinyl or monoallyl ethers, achieve this object.

The present invention accordingly provides copolymers obtainable by polymerization of the monomers (A), (B) and (C), where

(A) is a monomer of formula (I)

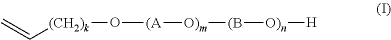

where
A represents C₂- to C₄-alkylene,
B represents a C₂- to C₄-alkylene other than A,
k equals 0 or 1,
m is from 0 to 500, preferably from 0 to 50,
n is from 0 to 500, preferably from 0 to 50,
provided the sum total of m+n is from 1 to 1000;
(B) is an ethylenically unsaturated monomer which contains an aromatic group; and
(C) is an ethylenically unsaturated monomer which contains an alkyl radical.

The copolymer of the present invention possesses customary terminal groups which are formed by the initiation of the free-radical polymerization or by chain transfer reactions or by chain termination reactions, for example a proton, a group derived from a free-radical initiator or a sulfur-containing group derived from a chain transfer reagent.

The molar fraction of the monomers is preferably 1 to 80% for monomer (A), 0.1 to 80% for monomer (B) and 0.1 to 80% for monomer (C).

It is particularly preferable for the molar fraction of the monomers to be 10 to 70% for monomer (A), 10 to 60% for monomer (B) and 10 to 60% for monomer (C).

In preferred monomers (A) A represents ethylene and B represents propylene, or A represents propylene and B represents ethylene.

The alkylene oxide units (A-O)ₘ and (B-O)ₙ can be present either randomly or, in the case of a preferred embodiment, arranged blocklike.

The sum total of the alkylene oxide units can in principle be n+m=1 to 1000, preference being given to 1 to 500, particularly 2 to 100, more preferably 5 to 100.

Preferred monomers (B) can be described by formula (IIa) or formula (IIb):

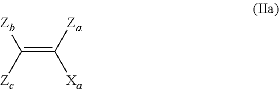

where
Xₐ represents an aromatic or araliphatic radical having 3 to 30 carbon atoms, which optionally contains one or more of the heteroatoms N, O and S,
Zₐ represents H or (C₁-C₄)-alkyl,
Z_{b} represents H or (C₁-C₄)-alkyl, and
Z_{c} represents H or (C₁-C₄)-alkyl;

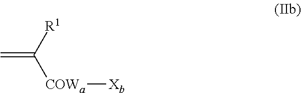

where
R¹ represents hydrogen or methyl,
X_{b} represents an aromatic or araliphatic radical having 3 to 30 carbon atoms, which optionally contains one or more heteroatoms N, O and S,
Wₐ represents oxygen or the group NH.

Monomers (B) include for example the following esters and amides of acrylic acid and methacrylic acid: phenyl, benzyl, tolyl, 2-phenoxyethyl, phenethyl.

Further monomers (B) are vinylaromatic monomers such as styrene and its derivatives such as for example vinyltoluene, alpha-methylstyrene. The aromatic unit may also comprise neteroaromatics, as in 1-vinylimidazole for example. Particularly preferred monomers (B) can be: styrene, 1-vinylimidazole, benzyl methacrylate, 2-phenoxyethyl methacrylate and phenethyl methacrylate.

Preferred monomers (C) can be described by formula (IIIa) or Formel (IIIb):

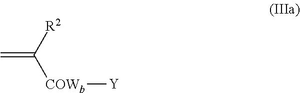

where
R² represents hydrogen or methyl,
Y represents an aliphatic hydrocarbyl radical having 1 to 30 carbon atoms, preferably 6 to 30, particularly 9 to 20 carbon atoms, which may be linear or branched or else cyclic, and may contain the heteroatoms O, N and/or S and also be unsaturated,
W_{b} represents oxygen or the group NH;

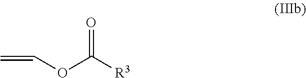

where
R³ represents an aliphatic hydrocarbyl radical having 1 to 30 carbon atoms, preferably 6 to 20, particularly 8 to 12 carbon atoms, which may be linear or branched or else cyclic, and may contain the heteroatoms O, N and/or S and also be unsaturated.

The monomers (C) include for example the following esters and amides of acrylic acid and methacrylic acid: methyl, ethyl, propyl, isopropyl, n-butyl, isobutyl, t-butyl, pentyl, hexyl, 2-ethylhexyl, 3,3-dimethylbutyl, heptyl, octyl, isooctyl, nonyl, lauryl, cetyl, stearyl, behenyl, cyclohexyl, trimethylcyclohexyl, t-butylcyclohexyl, bornyl, isobornyl, adamantyl, (2,2-dimethyl-1-methyl)propyl, cyclopentyl, 4-ethylcyclo-hexyl, 2-ethoxyethyl, tetrahydrofurfuryl and tetrahydropyranyl.

The monomers (C) further include the vinyl esters of carboxylic acids, such as, for example, vinyl laurate, vinyl myristate, vinyl stearate, vinyl behenate, vinyl pivalate, vinyl neohexanoate, vinyl neoheptanoate, vinyl neooctanoate, vinyl neononanoate, vinyl neodecanoate and vinyl neoundecanoate. It is likewise possible to use the vinyl esters of mixtures of such carboxylic acids.

Preferred monomers (C) are the following alkyl esters and alkylamides of acrylic acid and methacrylic acid: methyl, ethyl, propyl, butyl, isobutyl, 2-ethoxyethyl, myristyl, octadecyl and more preferably 2-ethylhexyl and lauryl.

The copolymers of the present invention have a molecular weight of 10³ g/mol to 10⁹ g/mol, more preferably 10³ to 10⁷ g/mol and even more preferably 10³ to 10⁵ g/mol.

Combining the monomers (A) with the aromatic and aliphatic monomers (B) and (C) makes it possible to emulate the properties of novolak-type dispersants such that a very similar performance profile is obtained.

The copolymers of the present invention are obtainable by means of free-radical polymerization. The polymerization reaction can be carried out continuously, batchwise or semi-continuously.

The polymerization reaction is advantageously carried out as a precipitation polymerization, emulsion polymerization, solution polymerization, bulk polymerization or gel polymerization. Solution polymerization is particularly advantageous for the performance profile of the copolymers of the present invention.

Useful solvents for the polymerization reaction include all organic or inorganic solvents which are very substantially inert with regard to free-radical polymerization reactions, examples being ethyl acetate, n-butyl acetate or 1-methoxy-2-propyl acetate, and also alcohols such as for example ethanol, i-propanol, n-butanol, 2-ethylhexanol or 1-methoxy-2-propanol, similarly diols such as ethylene glycol and propylene glycol. It is also possible to use ketones such as acetone, butanone, pentanone, hexanone and methyl ethyl ketone, alkyl esters of acetic, propionic and butyric acids such as for example ethyl acetate, butyl acetate and amyl acetate, ethers such as tetrahydrofuran, diethyl ether and ethylene glycol monoalkyl ethers, ethylene glycol dialkyl ethers, polyethylene glycol monoalkyl ethers and polyethylene glycol dialkyl ethers. It is similarly possible to use aromatic solvents such as for example toluene, xylene or higher-boiling alkylbenzenes. It is similarly conceivable to use solvent mixtures, in which case the choice of solvent or solvents depends on the use intended for the copolymers of the present invention. Preference is given to using water; lower alcohols; preferably methanol, ethanol, propanols, iso-, sec- and t-butanol, 2-ethylhexanol, butyl glycol and butyl diglycol, more preferably isopropanol, t-butanol, 2-ethylhexanol, butyl glycol and butyl diglycol; hydrocarbons having 5 to 30 carbon atoms and mixtures and emulsions of the aforementioned compounds. Methyl ethyl ketone, methyl isobutyl ketone and isopropanol are particularly preferred solvents.

The polymerization reaction is preferably carried out in the temperature range between 0 and 180° C., more preferably between 10 and 100° C., not only at atmospheric pressure but also under elevated or reduced pressure. Where appropriate, the polymerization can also be carried out under an inert gas atmosphere, preferably under nitrogen.

The polymerization can be initiated using high-energy electromagnetic rays, mechanical energy or the customary, chemical polymerization initiators such as organic peroxides, for example benzoyl peroxide, tert-butyl hydroperoxide, methyl ethyl ketone peroxide, cumoyl peroxide, dilauroyl peroxide (DLP), or azo initiators, for example azobisisobutyronitrile (AIBN), azobisamidopropyl hydrochloride (ABAH) and 2,2′-azobis(2-methylbutyronitrile) (AMBN). It is likewise possible to use inorganic peroxy compounds, for example (NH₄)₂S₂O₈, K₂S₂O₈ or H₂O₂, optionally combined with reducing agents (for example sodium hydrogensulfite, ascorbic acid, iron(II) sulfate) or redox systems which contain an aliphatic or aromatic sulfonic acid (for example benzenesulfonic acid, toluenesulfonic acid) as reducing component.

The usual compounds are used as molecular weight regulators. Suitable known regulators are for example alcohols, such as methanol, ethanol, propanol, isopropanol, n-butanol, sec-butanol and amyl alcohols, aldehydes, ketones, alkylthiols, for example dodecylthiol, tert-dodecylthiol, thiolglycolic acid, isooctyl thioglycolate and some halogen compounds, for example carbon tetrachloride, chloroform and methylene chloride.

The present invention further provides for the use of the copolymer of the present invention as a dispersant, particularly for pigments and fillers, for example in the manufacture of waterborne pigment concentrates used for coloring emulsion and varnish colors, paints, coatings and printing inks, and also for coloring paper, cardboard and textiles.

### SYNTHESIS EXAMPLES

### Synthesis Prescription 1

A flask equipped with a stirrer, reflux condenser, internal thermometer and a nitrogen inlet was initially charged with monomer A, monomer C and, where appropriate, the molecular weight regulator in solvent while nitrogen was being introduced. Then, the temperature was raised to 80° C. with stirring and a solution of the initiator was added during one hour by metering. At the same time, the metered addition was commenced of monomer B, and it was concluded after 3 hours. The batch was subsequently further stirred at this temperature for 2 hours, and then the solvent was removed under reduced pressure.

### Synthesis Prescription 2

A flask equipped with stirrer, reflux condenser, internal thermometer and nitrogen inlet was initially charged with monomer A, monomer C and, where appropriate, the molecular weight regulator and component 1 (ascorbic acid) of the redox initiator system in solvent under nitrogen. Then, the temperature was raised to 80° C. with stirring and a solution of component 2 (t-BuOOH) of the redox initiator system was added during three hours by metering. At the same time the metered addition was commenced of monomer B, and it was concluded after 3 hours. The batch was subsequently further stirred at this temperature for 2 hours, and then the solvent was removed under reduced pressure.

The following three tables contain synthesis examples carried out similarly to the above two general synthesis prescriptions.

AMBN=2,2′-azobis(2-methylbutyronitrile)

TABLE 1

| | | 1 | 2 | 3 | 4 | 5 | 6 | 7 | 8 | 9 | 10 |
|---|---|---|---|---|---|---|---|---|---|---|---|
| Monomer C | 2-ethylhexyl methacrylate | 136.4 g | | | | | | | | | |
| | lauryl methacrylate | | | 175.0 g | | | | | | | |
| | stearyl methacrylate | | | | | 232.8 g | | | | | |
| | isobornyl methacrylate | | | | | | | 152.9 g | | | |
| | tetrahydrofurfuryl methacrylate | | | | | | | | | 117.1 g | |
| | vinyl neononanoate | | | | 78.3 g | | | | | | 78.3 g |
| | vinyl neodecanoate | | 84.3 g | | | | | | 84.3 g | | |
| | vinyl neoundecanoate | | | | | | 90.3 g | | | | |
| Monomer B | 1-vinylimidazole | | | | | 64.7 g | | 64.7 g | | | |
| | styrene | 71.6 g | 41.6 g | | 41.6 g | | | | | | 41.6 g |
| | benzyl methacrylate | | | | | | 70.4 g | | 70.4 g | | |
| | phenethyl methacrylate | | | 130.8 g | | | | | | | |
| | 2-phenoxyethyl methacrylate | | | | | | | | | 141.8 g | |
| Monomer A | polyglcyol 1 | | 300 g | | 300 g | | 300 g | | | | 300 g |
| | polyglycol 2 | 378.4 g | | 378.4 g | | 378.4 g | | | | 378.4 g | |
| | polyglycol 3 | | | | | | | 688 g | | | |
| | polyglycol 4 | | | | | | | | 3000 g | | |
| Initiator | AMBN | 16.5 g | 13.4 g | | 13.4 g | 16.5 g | 13.4 g | 16.5 g | 13.4 g | | |
| | dibenzoyl peroxide | | | 20.8 g | | | | | | | |
| | ascorbic acid/t-BuOOH | | | | | | | | | 17.51 g/ | 17.51 g/ |
| | | | | | | | | | | 7.73 g | 7.73 g |
| Regulator | dodecanethiol | 16.5 g | | 16.5 g | | 16.5 g | | 16.5 g | | 16.5 g | 13.4 g |
| | ethyl mercaptan | | | | 4.2 g | | | | | | |
| Solvent | methyl ethyl ketone | 660 g | 660 g | | | 660 g | | | 660 g | 660 g | 660 g |
| | methyl isobutyl ketone | | | 660 g | 660 g | | | | | | |
| | isopropanol | | | | | | 660 g | 660 g | | | |
| | to synthesis prescription . . . | 1 | 1 | 1 | 1 | 1 | 1 | 1 | 1 | 2 | 2 |
| | M_{w} of polymer obtained | 14000 | 18500 | 10300 | 9000 | 12800 | 17900 | 15400 | 26200 | 11000 | 8800 |

TABLE 2

| | | 11 | 12 | 13 | 14 | 15 | 16 | 17 | 18 | 19 | 20 |
|---|---|---|---|---|---|---|---|---|---|---|---|
| Monomer C | 2-ethylhexyl | 136.4 g | | | | | | | | | |
| | methacrylate | | | | | | | | | | |
| | lauryl methacrylate | | | 175.0 g | | | | | | | |
| | stearyl methacrylate | | | | | 232.8 g | | | | | |
| | isobornyl methacrylate | | | | | | | 152.9 g | | | |
| | tetrahydrofurfuryl | | | | | | | | | 117.1 g | |
| | methacrylate | | | | | | | | | | |
| | vinyl neononanoate | | | | 78.3 g | | | | | | 78.3 g |
| | vinyl neodecanoate | | 84.3 g | | | | | | 84.3 g | | |
| | vinyl neoundecanoate | | | | | | 90.3 g | | | | |
| Monomer B | 1-vinylimidazole | | | | | 64.7 g | | 64.7 g | | | |
| | styrene | 71.6 g | 41.6 g | | 41.6 g | | | | | | 41.6 g |
| | benzyl methacrylate | | | | | | 70.4 g | | 70.4 g | | |
| | phenethyl methacrylate | | | 130.8 g | | | | | | | |
| | 2-phenoxyethyl | | | | | | | | | 141.8 g | |
| | methacrylate | | | | | | | | | | |
| Monomer A | polyglcyol 5 | | | | | | 210 g | | | | |
| | polyglycol 6 | | 300 g | | 300 g | | | | 300 g | | 300 g |
| | polyglycol 7 | 378.4 g | | 378.4 g | | 378.4 g | | 378.4 g | | 378.4 g | |
| Initiator | AMBN | 16.5 g | 13.4 g | | 13.4 g | 16.5 g | 13.4 g | | 13.4 g | | |
| | dibenzoyl peroxide | | | 20.8 g | | | | 20.8 g | | | |
| | ascorbic acid/t-BuOOH | | | | | | | | | 17.51 g/ | 17.51 g/ |
| | | | | | | | | | | 7.73 g | 7.73 g |
| Regulator | dodecanethiol | | 13.4 g | 16.5 g | | | 13.4 g | 16.5 g | | | 13.4 g |
| | ethyl mercaptan | | | | 4.2 g | | | | 4.2 g | | |
| Solvent | methyl ethyl ketone | 660 g | 660 g | | | 660 g | 660 g | | | 660 g | 660 g |
| | methyl isobutyl ketone | | | 660 g | 660 g | | | | | | |
| | isopropanol | | | | | | | 660 g | 660 g | | |
| | to synthesis | 1 | 1 | 1 | 1 | 1 | 1 | 1 | 1 | 2 | 2 |
| | prescription . . . | | | | | | | | | | |
| | M_{w} of polymer obtained | 16200 | 7500 | 6100 | 8200 | 14600 | 7000 | 15000 | 8900 | 14700 | 9200 |

TABLE 3

| | | 21 | 22 | 23 | 24 | 25 | 26 | 27 | 28 | 29 | 30 |
|---|---|---|---|---|---|---|---|---|---|---|---|
| Monomer C | 2-ethylhexyl methacrylate | 136.4 g | | | | | | | | | |
| | lauryl methacrylate | | | 175.0 g | | | | | | | |
| | stearyl methacrylate | | | | | 232.8 g | | | | | |
| | isobornyl methacrylate | | | | | | | 152.9 g | | | |
| | tetrahydrofurfuryl methacrylate | | | | | | | | | 117.1 g | |
| | vinyl neononanoate | | | | 78.3 g | | | | | | |
| | vinyl neodecanoate | | 84.3 g | | | | | | 84.3 g | | 78.3 g |
| | vinyl neoundecanoate | | | | | | 90.3 g | | | | |
| Monomer B | 1-vinylimidazole | | | | | 64.7 g | | 64.7 g | | | |
| | styrene | 71.6 g | 41.6 g | | 41.6 g | | | | | | 41.6 g |
| | benzyl methacrylate | | | | | | 70.4 g | | 70.4 g | | |
| | phenethyl methacrylate | | | 130.8 g | | | | | | | |
| | 2-phenoxyethyl methacrylate | | | | | | | | | 141.8 g | |
| Monomer A | polyglcyol 8 | | 300 g | | | 300 g | | | 300 g | | |
| | polyglycol 9 | 429 g | | | 429 g | | | | | 429 g | |
| | polyglycol 10 | | | 876 g | | | | 876 g | | | |
| | polyglycol 11 | | | | | | 1224 g | | | | 1224 g |
| Initiator | AMBN | 16.5 g | 13.4 g | | 13.4 g | 16.5 g | 13.4 g | | 13.4 g | | |
| | dibenzoyl peroxide | | | 20.8 g | | | | 20.8 g | | | |
| | ascorbic acid/t-BuOOH | | | | | | | | | 17.51 g/ | 17.51 g/ |
| | | | | | | | | | | 7.73 g | 7.73 g |
| Regulator | dodecanethiol | 16.5 g | 13.4 g | | | 16.5 g | | | | 16.5 g | |
| | ethyl mercaptan | | | | 4.2 g | | | | 4.2 g | | |
| Solvent | methyl ethyl ketone | 660 g | 660 g | | | 660 g | 660 g | | | | |
| | methyl isobutyl ketone | | | 660 g | 660 g | | | 660 g | 660 g | | |
| | isopropanol | | | | | | | | | 660 g | 660 g |
| | to synthesis prescription . . . | 1 | 1 | 1 | 1 | 1 | 1 | 1 | 1 | 2 | 2 |
| | M_{w} of polymer obtained | 8400 | 7900 | 13900 | 9000 | 8100 | 26200 | 15000 | 8600 | 8900 | 24800 |

Composition of monomer A in tables 1 to 3:
Polyglycol 1 polyalkylene glycol monovinyl ether (formula (I), k=0, n=0, m=11.5; (A-O) is (CH₂CH₂O)), molar mass about 550 g/mol
Polyglycol 2 polyalkylene glycol monovinyl ether (formula (I), k=0, n=0, m=24; (A-O) is (CH₂CH₂O)), molar mass about 1100 g/mol
Polyglycol 3 polyalkylene glycol monovinyl ether (formula (I), k=0, n=0, m=44.5; (A-O) is (CH₂CH₂O)), molar mass about 2000 g/mol
Polyglycol 4 polyalkylene glycol monovinyl ether (formula (I), k=0, n=0, m=135.4; (A-O) is (CH₂CH₂O)), molar mass about 6000 g/mol
Polyglycol 5 polyalkylene glycol monoallyl ether (formula (I), k=1, n=0, m=6.6; (A-O) is (CH₂CH₂O)), molar mass about 350 g/mol
Polyglycol 6 polyalkylene glycol monoallyl ether (formula (I), k=1, n=0, m=10; (A-O) is (CH₂CH₂O)), molar mass about 500 g/mol
Polyglycol 7 polyalkylene glycol monoallyl ether (formula (I), k=1, n=0, m=21.4; (A-O) is (CH₂CH₂O)), molar mass about 1000 g/mol
Polyglycol 8 polyalkylene glycol monoallyl ether (formula (I), k=1, ethylene oxide/propylene oxide 6:4 (random polymer), molar mass about 500 g/mol
Polyglycol 9 polyalkylene glycol monoallyl ether (formula (I), k=1, ethylene oxide (B-O)/propylene oxide (A-O) 11:4 (block copolymer), molar mass about 750 g/mol
Polyglycol 10 polyalkylene glycol monoallyl ether (formula (I), k=1, ethylene oxide (B-O)/propylene oxide (A-O) 20:10 (block copolymer), molar mass about 1500 g/mol
Polyglycol 11 polyalkylene glycol monoallyl ether (formula (I), k=1, ethylene oxide/propylene oxide 20:20 (random polymer), molar mass about 2100 g/mol

### Use Example

### Production of a Pigment Formulation

The pigment, in the form alternatively of powder, granulate or presscake, was pasted up in deionized water together with the dispersants and the other adjuvants and then homogenized and predispersed using a dissolver (for example from VMA-Getzmann GmbH, type AE3-M1) or some other suitable apparatus. Fine dispersion was subsequently effected using a bead mill (for example AE3-M1 from VMA-Getzmann) or else some other suitable dispersing assembly, with milling being carried out with siliquartzite beads or zirconium mixed oxide beads of size d=1 mm, accompanied by cooling, until the desired color strength and coloristics were obtained. Thereafter, the dispersion was adjusted with deionized water to the desired final pigment concentration, the grinding media separated off and the pigment formulation isolated.

### Evaluation of a Pigment Formulation

Color strength and hue were determined in accordance with DIN 55986. The rub-out test was carried out by applying the emulsion color, after mixing with the pigment dispersion, to a paint card. Subsequently, the applied coating was rubbed with the finger on the lower part of the paint card. Incompatibility was present if the rubbed area is then more strongly or brightly colored than the adjacent area not aftertreated (the rub-out test is described in DE 2 638 946). The color strength and the compatibilities with the medium to be colored was determined using an emulsion paint for exteriors (waterborne, 20% TiO₂).

Viscosity was determined using a cone-and-plate viscometer (Roto Visco 1) from Haake at 20° C. (titanium cone: Ø 60 mm, 1°), the relationship between viscosity and shear rate in a range between 0 and 200 s⁻¹ being investigated. Viscosities were measured at a shear rate of 60 s⁻¹.

To evaluate the storage stability of the dispersions, viscosity was measured directly after production of the formulation and also after four weeks' storage at 50° C.

The pigment formulation described in the example which follows was produced by the method described above, the following constituents being used in the stated amounts such that 100 parts of the pigment formulation are formed. Parts are by weight in the example below:

| | |
|---|---|
| 50 parts of | C.I. Pigment yellow 1 |
| 6 parts of | Polymer from synthesis example 3 (table) |
| 1 part of | wetter |
| 10 parts of | propylene glycol |
| 0.2 part of | preservative |
| 32.8 parts of | water |

The pigment formulation has high color strength in the white dispersion and is stable. The rub-out test did not show any color strength differences compared with the after-rubbed area. The dispersion proves to be very flowable and stable in storage, since it is still very flowable after 28 days' storage at 50° C. Viscosity in the as-produced state is 494 mPa·s.

1) A copolymer obtained by polymerization of the monomers (A), (B) and (C), where
(A) is a monomer of formula (I) 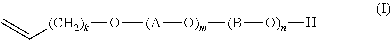
wherein
A is C₂- to C₄-alkylene,
B is a C₂- to C₄-alkylene other than A,
k equals 0 or 1,
m is from 0 to 500,
n is from 0 to 500,
provided the sum total of m+n is from 1 to 1000;
(B) is an ethylenically unsaturated monomer which contains containing an aromatic group; and
(C) is an ethylenically unsaturated monomer containing an alkyl radical.

2) The copolymer as claimed in claim 1, wherein the molar fraction of monomer (A) is 1 to 80%, the molar fraction of monomer (B) is 0.1 to 80% and the molar fraction of monomer (C) is 0.1 to 80%.

3) The copolymer as claimed in claim 1, wherein the molar fraction of monomer (A) is 10 to 70%, the molar fraction of monomer (B) is 10 to 60% and the molar fraction of monomer (C) is 10 to 60%.

4) The copolymer as claimed in claim 1, wherein the alkylene oxide units (A-O)ₘ and (B-O)ₙ are arranged blocklike.

5) The copolymer as claimed in claim 1, wherein the monomer (B) is a compound of formula (IIa) or (IIb): 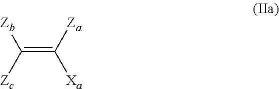
where wherein
Xₐ is an aromatic or araliphatic radical having 3 to 30 carbon atoms, optionally containing one or more of the heteroatoms N, O and S,
Zₐ is H or (C₁-C₄)-alkyl,
Z_{b} is H or (C₁-C₄)-alkyl, and
Z_{c} is H or (C₁-C₄)-alkyl; 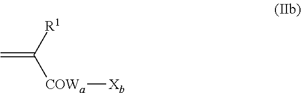
wherein
R¹ is hydrogen or methyl,
X_{b} is an aromatic or araliphatic radical having 3 to 30 carbon atoms, optionally containing one or more heteroatoms N, O and S,
Wₐ is oxygen or the group NH.

6) The copolymer as claimed in claim 1, wherein the monomer (C) is a compound of formula (IIIa) or (IIIb): 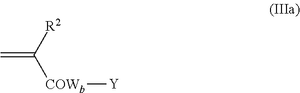
wherein
R² is hydrogen or methyl,
Y is an aliphatic hydrocarbyl radical having 1 to 30 carbon atoms, which is linear or branched or else cyclic, and optionally contains the heteroatoms O, N S or a combination thereof and may be unsaturated,
W_{b} is oxygen or the group NH; 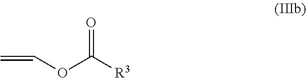
wherein
R³ is an aliphatic hydrocarbyl radical having 1 to 30 carbon atoms, which may be linear or branched or cyclic, and may contain the heteroatoms O, N, S or a combination and may be unsaturated.

7) The copolymer as claimed in claim 1, wherein the monomer (B) is styrene, 1-vinylimidazole, benzyl methacrylate, 2-phenoxyethyl methacrylate or phenethyl methacrylate.

8) The copolymer as claimed in claim 1, wherein the monomer (C) is an alkyl ester or alkylamide of acrylic or methacrylic acid, the alkyl is selected from the group consisting of methyl, ethyl, propyl, butyl, isobutyl, 2-ethylhexyl, 2-ethoxyethyl, myristyl, lauryl and octadecyl.

9) A process for preparing a copolymer as claim 1, comprising the step of free-radically polymerizing the monomers (A), (B) and (C).

10) A dispersant comprising the copolymer as claimed in claim 1.

11. A pigment or filler comprising the dispersant as claimed in claim 10.
